(19) United States
(12) Patent Application Publication
(10) Pub. No.: US 2020/0001828 A1
(43) Pub. Date: Jan. 2, 2020

(54) SYSTEM AND METHOD FOR THEFT PROTECTION FOR VEHICLE WHEELS OF A VEHICLE

(71) Applicant: Continental Automotive GmbH, Hannover (DE)

(72) Inventors: Michael LOEFFLER, Zeitlarn (DE); Juergen SPOTKA, Regenstauf (DE)

(21) Appl. No.: 16/471,985

(22) PCT Filed: Dec. 14, 2017
(86) PCT No.: PCT/EP2017/082786

§ 371 Date: Jun. 20, 2019

(30) Foreign Application Priority Data
Dec. 22, 2016 (DE) 10 2016 225 982.2

(51) Int. Cl. B60R 25/30; B60C 23/04; B60R 25/33

(52) U.S. Cl. CPC B60R 25/307; B60R 25/33; B60C 23/0479; B60C 23/0408

(57) ABSTRACT

The invention relates to a system (10) for theft protection for vehicle wheels (16) of a vehicle (14), having a database server (12) for managing vehicle wheel identification data (ID_{S}, ID_{W}) identifying vehicle wheels (16) and a controller (18), wherein the controller (18) has a communication connection to the database server (12) via a communication network (N), wherein the vehicle wheels (16) of the vehicle (14) are each equipped with an electronic wheel unit (20) for transmitting vehicle wheel identification data (ID_{S}, ID_{W}), respectively identifying the vehicle wheel (16) in question, to the controller (18), and wherein the controller (18) is designed to transmit the vehicle wheel identification data (ID_{S}, ID_{W}), transmitted by the electronic wheel units (20) of the vehicle wheels (16), to the database server (12) via the communication network (N).

The present invention relates to a system and to a method for theft protection for vehicle wheels of a vehicle.

Theft of vehicle wheels entails considerable economic losses, in particular for example in the case of relatively high-value vehicles.

Vehicle wheels that are of particular interest in the context of the invention, which are in each case formed of a wheel rim screwed to the vehicle and a tire mounted on the wheel rim, are stolen relatively often due to the ease of access to the wheel rim screw mechanism. If such theft is not resolved, then this means, for the owner, that the vehicle wheels in question are definitively lost.

US 2012/0126967 A1 discloses a method for detecting potential vehicle wheel theft. In this method, an electronic wheel unit, installed in the vehicle wheel in the form of a component of a tire pressure monitoring system, is used to detect removal of a tire from a vehicle (potential theft). The detection is based on the fact that, following removal of the tire, an expected transmission of information from the electronic wheel unit in question to a controller of the vehicle does not take place. In this case, there is provision for the controller or a telematics unit of the vehicle to automatically send a corresponding notification, for example to the vehicle owner and/or to another authority (for example vehicle fleet management, the police, etc.) via a wireless communication connection.

Since theft is not usually the underlying cause of a removal of a vehicle wheel from a vehicle, in the method known from US 2012/0126967 A1, it is possible for a multiplicity of notifications that are not actually required to be sent, which therefore have to be processed and evaluated.

One object of the present invention is to specify a system and a method for theft protection for vehicle wheels of a vehicle, which system and method enable good performance with simultaneously high comfort for users.

According to a first aspect of the invention, this object is achieved by a system for theft protection for one or more vehicle wheels of a vehicle, having a database server for managing vehicle wheel identification data identifying vehicle wheels and a controller, wherein the controller has a communication connection to the database server via a communication network (for example the Internet), wherein the vehicle wheels of the vehicle are each equipped with an electronic wheel unit for transmitting vehicle wheel identification data, respectively identifying the vehicle wheel in question, to the controller, and wherein the controller is designed to transmit the vehicle wheel identification data, transmitted by the electronic wheel units of the vehicle wheels, to the database server via the communication network.

The term “theft protection” used here should be understood in this case to mean that it also includes measures for early recognition and/or resolution of thefts that have taken place. In addition, the theft protection may relate not only to one or more vehicle wheels of the vehicle, but also to the vehicle itself. In this respect, said aspect of the invention also relates to a system for theft protection for the vehicle.

One significant advantage of the invention is in this case that, by automatically transmitting the vehicle wheel identification data from the controller to the database server via the communication network, a measure is provided by way of which a vehicle wheel that has already been stolen or a vehicle that has already been stolen is possibly able to be detected or determined. Specifically, if such a vehicle wheel is mounted on a (different) vehicle, then this is able to be detected following automatic transmission of its vehicle wheel identification data to the database server in the context of management of the vehicle wheel identification data performed on the part of the database server, as explained further below.

In this connection, it is preferred, in the management of the vehicle wheel identification data, for an item of information to be stored, in each case assigned to these data, as to whether or not the vehicle wheel in question or the vehicle itself has been reported as stolen. If the vehicle itself has been reported as stolen, then the theft of the vehicle is able to be detected or determined by way of the vehicle wheel identification data, transmitted to the database server, of the vehicle wheels belonging to the stolen vehicle.

The database server may in particular be a central apparatus for managing vehicle wheel identification data of a multiplicity of vehicles, wherein the database server may be operated for example by a private organization or a public organization (for example an authority, in particular a police authority).

A further advantage of the invention is that, by automatically transmitting the vehicle wheel identification data from the controller to the database server, the database server is provided with vehicle wheel identification data to be managed without additional effort on the part of the user.

In one embodiment, the controller is designed to transmit vehicle identification data, identifying the vehicle, to the database server via the communication network.

The controller may be arranged in the vehicle. In a further embodiment, the controller is arranged outside the vehicle. The controller may in particular be arranged in a further vehicle different from the vehicle, for example in a police vehicle. The controller may furthermore be arranged in a roadside infrastructure apparatus, also referred to as a road side unit.

The database server preferably has at least one communication interface to the Internet. In this case, the Internet may for example constitute the communication network. Furthermore, in this case, in a manner convenient for the management of the vehicle wheel identification data and/or of the vehicle identification data, further useful data such as for example user identifications (relating to owners of vehicles and/or vehicle wheels), contact data of users, etc. may be transmitted to the database server for management purposes.

The term “management of the vehicle wheel identification data” preferably encompasses not only merely storing the vehicle wheel identification data, but rather also an associated storage of the vehicle identification data identifying the vehicle in question and/or user identification data identifying owners (of vehicles or of vehicle wheels) and/or other authorized individuals (for example the police).

In this connection, it is in particular advantageous to store those vehicle identification data in each case assigned to the vehicle wheel identification data that identify the correct vehicle, that is to say that vehicle to which the vehicle wheel legally belongs.

There may also furthermore be provision in the management for authorized users (for example the police) to be able have particular database queries processed and answered automatically (for example via the Internet).

The database server is preferably designed to compare the vehicle wheel identification data with the vehicle identification data and/or with user identification data identifying users of the system.

In one embodiment, the vehicle wheel identification data of a respective vehicle wheel contain one or more of the following items of information: wheel rim manufacturer, wheel rim type, tire manufacturer, tire type, DOT code of the tire, identification of the electronic wheel unit.

In one embodiment, the vehicle identification data contain one or more of the following items of information: vehicle manufacturer, vehicle type, vehicle serial number.

In one embodiment, the user identification data contain at least login data for authenticating a user upon a transmission of data by the user to the database server or vice versa. The user identification data may furthermore for example contain one or more of the following items of information: name, address, further contact data.

To create the communication connection to the database server, the controller may be equipped with or connected to a radio apparatus (for example a mobile radio apparatus).

In one embodiment, the controller is equipped with or connected to a position determination apparatus (for example a satellite-assisted position determination apparatus, for example a GPS apparatus). In this case, the controller is additionally designed to transmit position data, in particular of the vehicle in question, to the database server via the communication network, for example together with the transmission of the vehicle wheel identification data and/or of the vehicle identification data to the database server.

In one embodiment, the controller is equipped with or connected to a storage apparatus in order to store the vehicle wheel identification data transmitted by the electronic wheel units. This makes it possible for example for the vehicle wheel identification data in principle to have to be transmitted to the controller only once, for instance during or following a wheel or tire change, which preserves the transmission path, designed for example as a radio connection, between the electronic wheel unit and the controller.

In one embodiment, the electronic wheel unit has a storage apparatus in order to store the vehicle wheel identification data in question. Many electronic wheel units of modern motor vehicles are advantageously already provided with a storage apparatus suitable for this purpose, for instance so as to create what is known as a tire information system (TIS).

In one embodiment, the electronic wheel unit has a pressure sensor for measuring a tire pressure of a tire of the vehicle wheel in question. Many electronic wheel units are provided with such a pressure sensor, for instance so as to create a tire pressure monitoring system (TPMS). In one development of this embodiment, the pressure sensor is used to detect a potential tire theft, wherein a drop in the tire pressure to atmospheric pressure may be evaluated as an indication of the potential tire theft. The circumstance of such a detection may be (buffer-) stored for example in an electronic wheel unit installed in the tire and be transmitted to a corresponding controller of another vehicle at the next opportunity, that is to say after the tire is mounted on the other vehicle, and relayed by way of this controller to the database server via the communication network.

The electronic wheel unit may generally be designed to detect a potential tire theft by way of a sensor system that is sensitive for example to a drop in the internal tire pressure to atmospheric pressure and/or for example to dismounting of the electronic wheel unit, and designed to transmit a corresponding notification to the controller on the basis of such a detection. The corresponding notification may take place for example by setting what is known as a flag in the vehicle wheel identification data.

In one embodiment, the electronic wheel unit has a radio apparatus in order to transmit the vehicle wheel identification data in question. This radio apparatus is accordingly designed to transmit the vehicle wheel identification data to the controller. The radio apparatus may additionally be designed to receive vehicle wheel identification data, for instance in the context of wireless programming of the electronic wheel unit with updated vehicle wheel identification data (for example during or following a wheel or tire change).

The vehicle or further vehicles with a communication connection to the database server via the communication network may in particular be for example automobiles or trucks.

All of the vehicle wheels mounted on the vehicle in question are preferably provided with an electronic wheel unit of the type described here.

According to a second aspect of the invention, the object provided at the outset is achieved by a method for theft protection for one or more vehicle wheels of a vehicle, comprising the following steps:
managing vehicle wheel identification data, identifying vehicle wheels, by way of a database server,
transmitting vehicle wheel identification data, respectively identifying one of a plurality of vehicle wheels of the vehicle, to a controller by way of a respective electronic wheel unit on the vehicle wheel in question,
transmitting the vehicle wheel identification data, transmitted by the electronic wheel units of the vehicle wheels, from the controller to the database server via a communication network.

All of the optional features and embodiments described here for the system according to the first aspect of the invention may be provided in the same way, alone or in any desired combination, including as particular refinements or embodiments of the method according to the second aspect of the invention.

In particular, the method may additionally involve transmitting vehicle identification data identifying the vehicle from the controller to the database server via the communication network.

As already explained, the invention may advantageously be used to detect a vehicle wheel reported as stolen, specifically for example if this vehicle wheel is mounted on another (incorrect or illegal) vehicle. In this respect, it is preferred for the system or the method to make provision, after each transmission of vehicle wheel identification data, for an automatic check to take place on the part of the database server in order to establish whether or not the vehicle wheel in question has been reported as stolen. If such a theft report exists, an automatic notification for example to the vehicle owner and/or to at least one other predetermined individual or organization (for example the police) may take place.

In one development of the invention, the system or the method is also used to detect a potential theft of a vehicle wheel. To this end, the controller may for example be designed, if an expected data transmission from an electronic wheel unit to the controller does not take place, to transmit a corresponding notification to the database server via the communication network.

As an alternative or in addition, to detect a potential theft, use may be made of a sensor system serving for this purpose in the electronic wheel unit, which sensor system is sensitive for example to a drop in the internal tire pressure to atmospheric pressure or for example to dismounting of the electronic wheel unit, wherein, on the basis of such a detection, a corresponding notification is transmitted for example to the controller and relayed from there to the database server. If such a notification to the controller is not possible or fails (since the controller is no longer within the range of the vehicle wheel), the circumstance of such a detection may be (buffer-)stored in the electronic wheel unit and transmitted to a corresponding controller of another vehicle at the next opportunity, that is to say following mounting of the electronic wheel unit on the other vehicle, and be relayed to the database server via the communication network or the communication connection.

To minimize false alarms in an embodiment with detection of a potential theft, for instance for cases of vehicle wheel or tire changes or the like carried out by the vehicle owner, in the management of the vehicle wheel identification data on the part of the database server, there is preferably the possibility of registering corresponding announcements by the vehicle owner and/or a predetermined (authorized) person in association with the vehicle identification data in question. Such announcement information may be transmitted for example by the vehicle owner or for example by workshop staff to the database server via the communication network, which is present in any case (or alternatively via a communication connection specifically provided for this purpose). Using such announcement information, it is able to be assessed, in the context of managing the vehicle wheel identification data, whether or not a received notification about the detection of a potential theft is actually based on a theft. If this is the case, forwarding of the notification to the vehicle owner or a predetermined other individual may for example be triggered (and suppressed if not).

In one development of the invention, it is provided for authorized individuals (for example the police) to be able to perform certain queries in relation to the data managed by the database server via the communication network (or another communication connection). This makes it possible for example, in the case of a police vehicle check, for it to be immediately checked whether a vehicle wheel installed on a vehicle actually belongs to this vehicle and/or whether this vehicle wheel or the vehicle itself has been reported as stolen.

The invention is described in more detail below on the basis of exemplary embodiments with reference to the enclosed drawings, in which:

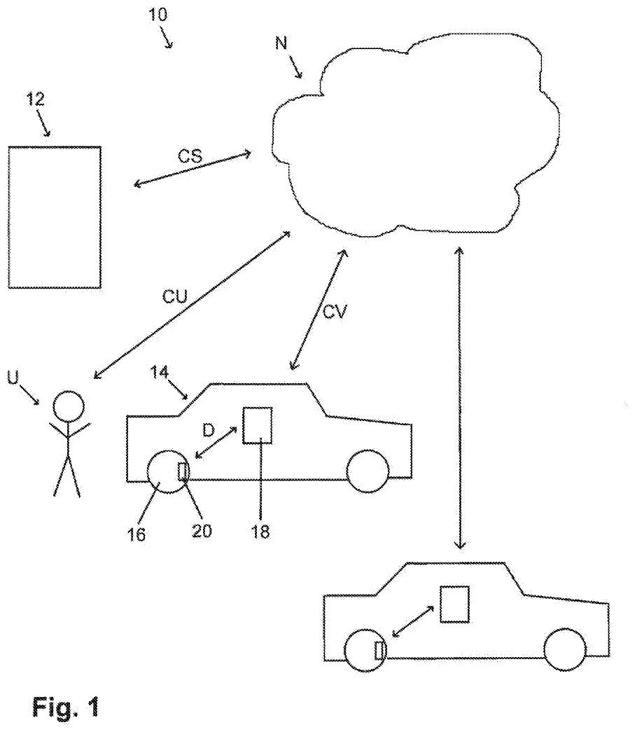

FIG. 1 shows a system for theft protection for vehicle wheels according to one exemplary embodiment,

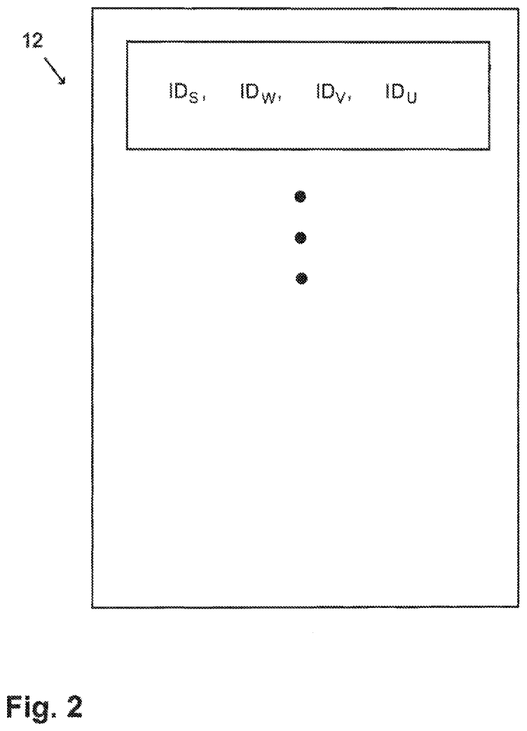

FIG. 2 shows an illustration for illustrating data that are managed by a database server of the system from FIG. 1, and

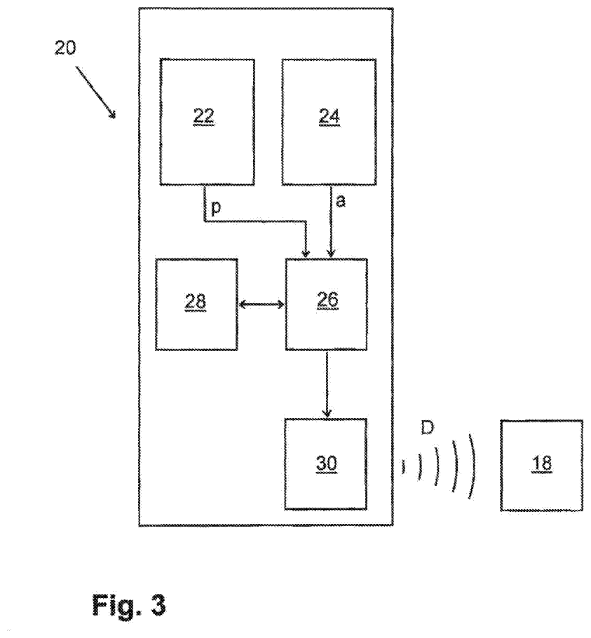

FIG. 3 shows a block diagram of an electronic wheel unit according to one exemplary embodiment.

FIG. 1 shows a system 10 for theft protection for vehicle wheels of vehicles, wherein, in FIG. 1, two of these vehicles (here: automobiles), incorporated into the system 10, are shown merely by way of example, and the following description is given just for the vehicle referenced with 14 in FIG. 1, for the sake of simplicity. The same applies for the other vehicle visible in FIG. 1 (and further vehicles, not illustrated in FIG. 1).

The system 10 contains a central database server 12 for managing vehicle wheel identification data identifying vehicle wheels and a multiplicity of vehicles that, in the embodiment that is shown, like the vehicle 14, are each equipped with at least one vehicle wheel 16 and a central controller 18 that forms a component of the vehicle electronics.

The vehicle wheel 16 that is illustrated, and the same applies for further vehicle wheels of the vehicle 14 and vehicle wheels of further vehicles incorporated into the system 10, is equipped with an electronic wheel unit 20 for transmitting vehicle wheel identification data, respectively identifying the vehicle wheel in question, to the controller 18 of the vehicle in question, that is to say to the controller 18 of the vehicle 14 in the embodiment that is shown, and/or to a corresponding controller of at least one vehicle different from the vehicle 14, for example to the controller of the other vehicle illustrated in FIG. 1. The electronic wheel unit 20 may furthermore transmit the vehicle wheel identification data identifying the vehicle wheel in question to at least one controller arranged in a roadside infrastructure apparatus (not illustrated). Very generally speaking, the vehicle wheel identification data may contain information about individual properties of the wheel rim and/or of the tire. Particularly preferably, the vehicle wheel identification data also contain an identification of the electronic wheel unit 20 (for example a uniquely assigned code for unambiguously identifying the electronic wheel unit 20).

The vehicle wheel 16 is formed by a wheel rim that is screwed to a wheel hub of the vehicle 14 and a tire mounted on the wheel rim, wherein the electronic wheel unit 20, in the example that is illustrated, is arranged on an inside of a running surface of the tire.

In the example that is illustrated, the electronic wheel unit 20 also constitutes a component of a tire pressure monitoring system (TPMS) formed in the vehicle 14, by way of which tire pressure monitoring system in particular tire pressure data indicating the tire pressure (together with an identification unambiguously identifying the electronic wheel unit 20) are thus transmitted to the controller 18, but furthermore also the mentioned vehicle wheel identification data.

The identification of the electronic wheel unit 20 is fixedly programmed into said wheel unit and allows the controller 18, in the context of the tire pressure monitoring, to assign received data D unambiguously to a particular one of the electronic wheel units, of which there are generally several installed on the vehicle. The vehicle wheel identification data, for example containing information about wheel rim manufacturer, wheel rim type, tire manufacturer and/or tire type, were programmed into the electronic wheel unit 20 during the mounting of the vehicle wheel 16, for example by workshop staff (for example through radio transmission of these data).

The controller 18 is equipped with a storage apparatus (not illustrated) in which vehicle identification data identifying the vehicle 14, for example containing information about vehicle manufacturer, vehicle type and/or vehicle serial number, are stored.

The storage apparatus (or another storage apparatus of the controller 18) is furthermore used to store the vehicle wheel identification data transmitted by the electronic wheel units.

The controller 18 is designed to transmit the vehicle wheel identification data transmitted by the electronic wheel unit 20 of the vehicle wheel 16 (and accordingly further vehicle wheel identification data relating to the further vehicle wheels of the vehicle 14) and the vehicle identification data identifying the vehicle 14 to the database server 12 via a communication network N (here: the Internet). To this end, the controller 18 has a communication connection to the database server 12 via the communication network N. As illustrated in FIG. 1, to this end, there is a communication connection CV, produced for example via a mobile radio apparatus of the vehicle 14, between the vehicle or its controller 18 and the network N, and a further communication connection CS between the network N and the database server 12.

The database server 12 manages the vehicle wheel identification data automatically transmitted in the manner described by the vehicles of the system 10 in each case in association with the vehicle identification data of the respectively associated vehicle and in association with user identification data identifying users of the system 10, for example containing information about name, address, further contact data and/or login data (for example user name and password) of the users in question.

Owners of the vehicles incorporated in the system 10 in particular come into consideration as users. Furthermore, user identification data may also be managed in the database server 12, for example by particular authorities, in particular for example the police.

FIG. 1 indicates, by way of example, a user U who is likewise able to communicate with the database server 12 via a communication connection CU to the network N.

As an alternative to communication via the illustrated communication connection CU (for example using a PC, a smartphone, etc.), the communication between the user U and the database server 12 may also take place using a human-machine interface (not illustrated) of the vehicle 14 and using the communication connection CV.

The management of the vehicle wheel identification data on the part of the database server 12 furthermore takes place in respective association with the identification of that electronic wheel unit that is installed in that vehicle wheel to which the vehicle wheel identification data relate.

FIG. 2 illustrates, by way of example, a dataset, stored in the database server 12, relating to the vehicle wheel 16 of the vehicle 14 shown in FIG. 1. This dataset contains an identification ID_{S} of the electronic wheel unit 20 installed in the vehicle wheel 16, further vehicle wheel identification data ID_{W} identifying the vehicle wheel 16 (for example wheel rim manufacturer, wheel rim type, tire manufacturer, tire type, DOT code of the tire, etc.), vehicle identification data ID_{V} identifying the vehicle 14 (for example vehicle manufacturer, vehicle type, vehicle serial number, etc.) and user identification data ID_{U} identifying the owner of the vehicle 14. Corresponding datasets are stored for the other vehicle wheels of the vehicle 14.

Corresponding datasets are stored in the database server 12 for further vehicle owners or vehicles and their corresponding wheel systems incorporated into the system 10.

FIG. 3 shows the structure of the electronic wheel unit 20 used in the example that is illustrated.

The electronic wheel unit 20 contains a pressure sensor 22 for providing a tire pressure signal p indicating the tire pressure and an acceleration sensor 24 for providing an acceleration signal a indicating a radial acceleration. The signals, that is to say the tire pressure signal p and the acceleration signal a, are fed to an evaluation apparatus 26 (for example to a microcontroller), which produces data D to be transmitted to the controller 18 of the vehicle 14 therefrom, which data are transmitted in the form of radio signals to the controller 18 equipped with or connected to a radio receiver (not illustrated) by way of a radio apparatus 30.

The electronic wheel unit 20 furthermore contains a storage apparatus 28, assigned to the evaluation apparatus 26, for storing software that controls the operation of the evaluation apparatus 26. The storage apparatus 28 is furthermore used to store the vehicle wheel identification data programmed in by workshop staff, for example.

During operation of the electronic wheel unit 20, the evaluation apparatus 26 may use the acceleration signal a in particular for example to determine a rotational angular velocity and/or a rotational angular position of the vehicle wheel 16. There may furthermore be determination of a length of a tire contact area, for example. Such information and/or information derived therefrom may enter, for example in digitally coded form, into the data D to be transmitted, together with results of the tire pressure measurement performed by the pressure sensor 22. Furthermore, in this way, the vehicle wheel identification data are transmitted to the controller 18 at least once, as already mentioned, and stored there.

The electronic wheel unit 20 may furthermore be designed to detect a potential tire theft by way of a sensor system that is sensitive for example to a drop in the internal tire pressure to atmospheric pressure and/or for example to dismounting of the electronic wheel unit 20, and designed to transmit a corresponding notification to the controller 18 on the basis of such a detection. The corresponding notification may take place for example by setting what is known as a flag in the vehicle wheel identification data ID_{W}. The pressure sensor 22 may be used in particular to detect a potential tire theft, wherein a drop in the tire pressure to atmospheric pressure may be evaluated by way of the evaluation apparatus 26 as an indication of the potential tire theft.

Advantageously, by automatically transmitting the vehicle wheel identification data ID_{W} from the vehicle 14 (and correspondingly from further vehicles) to the database server 12, vehicle wheel identification data to be managed are provided to the database server 12 without additional effort on the part of the user.

A further advantage of the system 10 is that, under some circumstances, a vehicle wheel stolen from a vehicle may be traced or determined, specifically for example if such a vehicle wheel is mounted on another vehicle, such that, as a result of the transmission of the vehicle wheel identification data that then takes place, in connection with other or incorrect vehicle identification data, it is able to be established that the vehicle wheel in question has changed vehicle.

In such a case, a corresponding notification from the database server 12 to the vehicle owner and/or at least one other predetermined individual or organization (for example the police) may take place automatically, for example.

In this connection, there may also be provision, in the database server 12, for an item of information to be stored, in each case assigned to the vehicle wheel identification data (and/or vehicle identification data) stored there, as to whether or not the vehicle wheel (or vehicle) in question has been reported as stolen. Such indications of theft may be transmitted for example by a user U to the database server 12 via the communication connection CU illustrated in FIG. 1.

Furthermore, impending mounting or dismounting or changing (to another vehicle) of a vehicle wheel may be announced to the database server 12 via the communication connection CU, for example, such that, if a potential theft is detected, the database server 12 is initially able to perform a check based on the registered announcement information before a corresponding notification to a user provided for this purpose is triggered.

The communication connection CU may furthermore be used for example by the police in order to have particular database queries processed and answered automatically by the database server 12 (for example via the same communication connection CU).

In summary, in the exemplary embodiment that is described, a largely automated and centralized registration of vehicle wheel identification data is performed.

The database server 12 in this case provides an updatable central database for registered users, possibly including public entities (for example the police). Since electronic TPMS wheel units typically each store an identification unambiguously identifying the wheel unit, such electronic wheel units may advantageously be used in the context of the invention since vehicle wheel identification data are furthermore stored therein, which vehicle wheel identification data, together with the identification of the wheel unit, thus form a unique dataset that is managed by the database server 12 and allows corresponding tracking and queries on the part of registered users or the police.

One significant aspect with regard to detection of a stolen object (for example a tire or an entire vehicle wheel) is the transmission of the corresponding vehicle wheel identification data and/or the identification of the electronic wheel unit from the stolen object to a central database, which is formed here of data stored in the respective controller.

This decentralized database in each vehicle is in turn used to transmit the information content thereof and corresponding information from other vehicles to the central database (database server). The database server is thus able to correlate all of the data arising in the system and manage them accordingly.

It is particularly advantageous here for each vehicle owner to be able to report his vehicle and/or its vehicle wheels as stolen following a theft. Such theft reports may take place for example via a human-machine interface of the vehicle or for example via another interface to the communication network or the database server, and lead to this information (theft indication) being stored in association with the vehicle identification data or vehicle wheel identification data in question.

Since the vehicles incorporated in the system are able to communicate with the database server via the communication network (for example the Internet), the database stored therein is able to be easily updated and/or queried. In the central database, for example, precisely one registered user (owner) and/or precisely one registered vehicle may be assigned to a particular identification of an electronic wheel unit (ID_{S}).

If for example an assembly consisting of wheel rim, tire and electronic wheel unit has been stolen from a vehicle, then the user of the vehicle is able to inform the police about this. This user himself (if registered as a user of the system) and/or the police (if registered as a user) may then possibly indicate this theft to the database server, such that, in the management of vehicle wheel identification data performed by the database server, the vehicle wheel identification data in question (of the stolen vehicle wheels) are able to be marked in the database as reported as stolen. Furthermore, the identification of the electronic wheel units in question may be marked in the database as reported as stolen.

In this example, the two following scenarios are then in particular possible for determining a stolen vehicle wheel:
In a police vehicle check involving performing a query on the database server, it is established that a vehicle wheel situated on the vehicle or an electronic wheel unit installed therein has been reported as stolen. In this case, the owner may accordingly be notified, whether by the police and/or automatically by the database server.
If a stolen vehicle wheel (including electronic wheel unit) is mounted on another vehicle incorporated into the system and the corresponding vehicle wheel identification data are thus transmitted to the database server, then, in the management of the vehicle wheel identification data, the database server may establish the theft, whereupon a corresponding notification may be sent. Establishing the theft may in this case be based upon the fact that the transmitted vehicle wheel identification data (or an identification, contained therein, of the electronic wheel unit) are already registered in the database as reported as stolen. As an alternative, establishing the theft may be based for example upon the fact that the transmitted vehicle wheel identification data (or the identification of the electronic wheel unit) are not registered in the database as reported as stolen, but an association with another vehicle is registered. In this case, for example, a warning notification may be sent to the user registered as owner. As an alternative, this sending may be performed depending on whether this user has previously transmitted corresponding announcement information (relating here to changing a vehicle wheel from a first vehicle to a second vehicle) to the database server. The notification to the registered owner may possibly contain position information relating to the location of the vehicle (if position data has been transmitted to the database server by the controller of this vehicle). As an alternative or in addition, the notification sent to the user may possibly contain information about the vehicle (for example the vehicle identification data or part thereof).

### LIST OF REFERENCE SIGNS

10 System
12 Database server
ID_{S} Identification
ID_{V} Vehicle identification data
ID_{W} Vehicle wheel identification data
ID_{U} User identification data
14 Vehicle
16 Vehicle wheel
18 Controller
20 Wheel unit
22 Pressure sensor
p Tire pressure signal
24 Acceleration sensor
a Acceleration signal
26 Evaluation apparatus
28 Storage apparatus
30 Radio apparatus
D Data
N Communication network
CS, CV, CU Communication connection
U User

1. A system for theft protection for vehicle wheels of a vehicle, comprising a database server configured to manage in vehicle wheel identification data identifying vehicle wheels and a controller, wherein the controller has a communication connection to the database server via a communication network, wherein the vehicle wheels of the vehicle are each equipped with an electronic wheel unit for transmitting vehicle wheel identification data, respectively identifying the vehicle wheel in question, to the controller, and wherein the controller is configured to transmit the vehicle wheel identification data, transmitted by the electronic wheel units of the vehicle wheels, to the database server via the communication network.

2. The system as claimed in claim 1, wherein the controller is configured to transmit vehicle identification data, identifying the vehicle, to the database server via the communication network.

3. The system as claimed in claim 1, wherein the controller is arranged in the vehicle.

4. The system as claimed in claim 1, wherein the controller is arranged outside the vehicle.

5. The system as claimed in claim 4, wherein the controller is arranged in at least one of a further vehicle, different from the vehicle, and a roadside infrastructure apparatus.

6. The system as claimed in claim 2, wherein the database server is configured to compare the vehicle wheel identification data with at least one of the vehicle identification data and user identification data identifying users of the system.

7. The system as claimed in claim 1, wherein the vehicle wheel identification data of a respective vehicle wheel comprises one or more of: wheel rim manufacturer, wheel rim type, tire manufacturer, tire type, DOT code of the tire, identification of the electronic wheel unit.

8. The system as claimed in claim 2, wherein the vehicle identification data comprises one or more of: vehicle manufacturer, vehicle type, vehicle serial number.

9. The system as claimed in claim 1, wherein the controller comprises or is connected to a radio apparatus.

10. The system as claimed in claim 1, wherein the controller comprises or is connected to a position determination apparatus, and wherein the controller is configured to transmit position data to the database server via the communication network.

11. The system as claimed in claim 1, wherein the controller comprises or is connected to a storage apparatus configured to store the vehicle wheel identification data transmitted by the electronic wheel units.

12. The system as claimed in claim 1, wherein the electronic wheel unit comprises a storage apparatus configured to store the respective vehicle wheel identification data.

13. The system as claimed in claim 1, wherein the electronic wheel unit comprises a pressure sensor for measuring a tire pressure of a tire of the respective vehicle wheel.

14. The system as claimed in claim 1, wherein the electronic wheel unit is configured to detect a potential tire theft, and wherein the electronic wheel unit is further configured to transmit a corresponding notification to the controller in response to such a detection.

15. The system as claimed in claim 1, wherein the electronic wheel unit comprises a radio apparatus.

16. A method for theft protection for vehicle wheels of a vehicle, comprising:
managing vehicle wheel identification data, identifying vehicle wheels, at a database server,
transmitting vehicle wheel identification data, respectively identifying one of a plurality of vehicle wheels of the vehicle, to a controller by a respective electronic wheel unit on the respective vehicle wheel,
transmitting the vehicle wheel identification data, transmitted by the electronic wheel units of the vehicle wheels, from the controller to the database server via a communication network.

17. The method as claimed in claim 16, further comprising transmitting vehicle identification data, identifying the vehicle, from the controller to the database server via the communication network.

18. A non-transitory computer readable medium comprising program code which, when executed on a data processing apparatus, performs a method as claimed in claim 16.

19. A non-transitory computer readable medium comprising program code which, when executed on a data processing apparatus, performs a method as claimed in claim 17.
